(19) United States
(12) Patent Application Publication
(10) Pub. No.: US 2026/0124643 A1
(43) Pub. Date: May 7, 2026

(54) Plasma induced crystallization and densification of amorphous coatings

(71) Applicants: SCHOTT AG, Mainz (DE); SCHOTT GLASS TECHNOLOGIES (SUZHOU) CO. LTD., Suzhou, Jiangsu (CN)

(72) Inventors: Stefanie STUCKENHOLZ, Darmstadt (DE); Fang Tong XIE, Mainz (DE); Yakup GOENUELLUE, Essenheim (DE); Stephanie MANGOLD, Schornsheim (DE); Sonja Mareike BREUNIG, Gross-Gerau (DE); Eveline RUDIGIER-VOIGT, Mainz (DE)

(21) Appl. No.: 19/117,575

(22) PCT Filed: Oct. 11, 2022
(86) PCT No.: PCT/CN2022/124624

§ 371 Date: Apr. 1, 2025

(51) Int. Cl. B05D 3/14

(52) U.S. Cl. CPC B05D 3/145

(57) ABSTRACT

A method for coating a substrate and a respectively coated substrate. The created coating is characterized by a crystalline and dense structure which is particularly suitable for applying further layers of coatings onto it. The method uses a plasma for curing the applied solution instead of a thermal curing and is, hence, faster, less energy consuming, and applicable to more temperature sensitive substrates.

The present invention relates to a method for coating a substrate and a respectively coated substrate. The created coating is characterized by a crystalline and dense structure which is particularly suitable for applying further layers of coatings thereon.

### BACKGROUND

Many substrates are provided with a coating in order to achieve a certain desired effect or enhancement of properties. Depending on the application, the coatings have a thickness in the range from several nanometers up to some millimeters. For example, for optic lenses and ophthalmic lenses typically several layers of coatings in the range from nanometers to micrometers are applied for providing the glass or polymer with UV filter, anti-reflective, and anti-scratch properties as well as chemical resistivity.

For the application of coatings of such a thickness, in general a sol-gel-process is used. A solution of the coating medium or a precursor of the same is prepared in a first step and then spread by different techniques onto the substrate for the creation of a thin liquid film. Finally, the solvent is evaporated from the film to obtain the coating.

### SUMMARY OF THE INVENTION

Since these coatings on substrates are often amorphous after this initial coating step, usually a curing in form of a thermal annealing step is applied as a further step to crystallize, densify, and/or modify the coating. The thermal annealing leads to different film modifications, depending on the applied temperature program. The evaporation of the solvent in the initial coating step is done by heating the substrate only to moderate temperatures-if heating at all-whereas the curing step requires much higher temperatures. The coating is always applied on a substrate with certain restrictions regarding the maximum temperature that can be applied in a thermal annealing step. In many cases, the temperature required by common coating substances is too high for temperature sensitive substrates such as polymers. Moreover, the curing step is often also quite time and energy consuming. Conventional annealing of sol-gel coatings usually takes place at high temperatures of several hundred degrees Celsius for durations of up to several hours.

A typical example of a coating on glass lenses made of soda lime glass is a UV protection layer consisting of ZnO. In a standard sol-gel-coating process on a soda lime glass, the ZnO coating is applied via dip coating (v=30 cm/min), dried in a first step for 6 min at 145° C., and annealed in a second step for 60 min at 500° C. The second heating step is intended to bring the coating from an amorphous state into a crystalline state and to burn off any organic binder in the system. The goal is to achieve a dense and crystalline ZnO film on the soda lime glass. However, the second heating step leads in the case of ZnO coatings on glass only to a binder burn off and to a crystallization of the ZnO, but results in a highly porous film. Such a highly porous film is not—or at most very limited—suitable for the application of further layers of coatings. Additionally, the high temperatures put a lot of thermal stress on the substrate. A crystallization of the coating system of ZnO on a polymeric substrate is, due to the temperature restrictions of the substrate, not feasible with thermal annealing.

This example of the ZnO coating is illustrative for the problems faced with sol-gel-coatings of different kinds of coating materials on diverse substrates. While the curing times and temperatures may vary, the basic problems of high temperatures, long annealing times, high energy consumption, insufficient crystallinity, and insufficient density are persistent.

Moreover, these problems described by means of the example of a sol-gel-process and particularly a ZnO coating likewise affect other coating processes using liquid solutions and requiring a thermal annealing step for curing the initially created amorphous layer.

An object underlying the present invention is to provide an improved coating process which does not or at least to a lesser extent suffer the problems of the prior art. In particular, a coating process should be provided which results in a coating suitable for applying further layers onto it.

The present invention can be used in the field of coatings, in particular sol-gel-coatings, on substrates (e.g. glass, polymers, metals or other materials) that comprise an annealing step with the goal of densification, crystallization or other morphological changes of the coating, particularly for the purpose of making the coating suitable as a base layer for further layers.

The method uses a plasma for curing the applied solution instead of a thermal curing and is, hence, faster, less energy consuming, and applicable to more temperature sensitive substrates.

The inventors have discovered that the thermal annealing step to modify the morphology (state of crystallization/modification and/or density and surface roughness) and resulting film properties (e.g. UV absorption, hardness, chemical resistivity) may advantageously be exchanged with a plasma treatment step. Surprisingly, not only the treatment temperature and time can be reduced, but at the same time also the resulting and attainable properties of the coatings are improved. This is quite unexpected because the expectation had been that the crystallization of the amorphous coating requires sufficiently high temperatures and enough time for the formation of a dense crystallite morphology. Hence, there had been concerns that the surface roughness, the porosity, and the crystallite size would deteriorate by the application of a plasma instead of the temperature treatment.

However, contrary to those expectations, the achieved advantage is, that high energy can be brought into the film system, leading to desired film properties, not realizable with thermal annealing in the same time and/or at substrate temperatures as low as in the plasma process. This allows new combinations of film-substrate-variations (in particular regarding thermally sensitive substrates).

In a first aspect, the invention provides a method for coating a substrate comprising the steps of
a) providing a substrate,
b) applying a coating solution on a surface of the substrate,
c) thermally drying the coating solution to form an amorphous coating, and
d) treating the amorphous coating with a plasma treatment to form an at least partially crystalized coating.

This method results in coatings which are suitable as a base layer for further coting layers in an excellent manner. The resulting coating can have much less pores, a higher average degree of crystallinity, a higher density, and/or a lower surface roughness. The crystallites are small enough to achieve a low porosity and have only small areas of a less than 100% degree of crystallization. Even if there is used a binder in the coating solution, the coating can still have a very low porosity and an improved microstructure as compared to the prior art coating processes, in particular sol-gel-processes, with thermal annealing. Moreover, the process may easily be adjusted by variation of the plasma treatment time and energy to produce a certain desired microstructure of the coating.

In particularly preferred embodiments, the coating solution is a sol-gel based coating solution and is applied in a sol-gel-process. Here, the term “sol-gel based coating solution” is referring to a coating solution which is a colloidal solution capable of acting as a precursor for an integrated network or gel and, hence, suitable for use in a sol-gel coating process.

In embodiments, the plasma treatment comprises creating a radio frequency plasma or a microwave plasma, in particular at a frequency of 10 MHz to 300 MHz or 300 MHz to 300 GHz. Preferably, the plasma is generated at a frequency of 10 MHz to 100 MHz or 1 GHz to 100 GHz. While plasma generators using one of the standard frequencies may be successfully used for the invention, a specific fine-tuning of the coating properties may be achieved by the application of a non-standard frequency within the claimed ranges. This allows for the flexible adaptation of the method to a desired combination of substrate and coating medium as well as required properties of the final coating for its intended function and suitability as a base layer for further layers.

Preferably, the plasma is generated by means of a radio frequency plasma generator with a capacitive electrode arrangement or a pulsed magnetron microwave generator.

In embodiments, the generator for the generation of the plasma is operated at a power of 0.2 kW-10 KW, preferably 0.3 kW-7 kW.

In preferred embodiments, the plasma is created in an atmosphere of oxygen, argon, nitrogen, air, or hydrogen either at ambient pressure or at reduced pressure, in particular in vacuo. Preferably, the plasma is created in an atmosphere of oxygen, air, argon, or nitrogen, more preferably in an atmosphere of oxygen or air. A hydrogen atmosphere or a certain percentage of hydrogen in an argon or nitrogen atmosphere may be used for doping. An oxygen plasma is in many cases particularly advantageous when a binder is used in the coating solution as it may help to burn off the binder. Also when certain precursors of the coating medium are used in the coating solution, the oxygen plasma may be the atmosphere to prefer.

In preferred embodiments, the plasma treatment time is from 0.1 s to 120 min, preferably from 1 s to 60 min, or from 30 s to 30 min, or from 1 min to 10 min. The plasma treatment time may be at least 0.1 s, at least 1 s, at least 30 s, or at least 1 min. The plasma treatment time may be at most 120 min, at most 60 min, at most 30 min, or at most 10 min. The plasma treatment time may be chosen according to the type of plasma used and its power. For example, for the radio frequency plasma a treatment time of 30 min to 120 min may be chosen, while for the microwave plasma a treatment time of 1 s to 10 min may be chosen.

In embodiments, the maximum treatment temperature does not exceed 400° C., preferably does not exceed 300° C. or does not exceed 150° C. The maximum treatment temperature may be at least 25° C., at least 30° C., at least 35° C., at least 40° C., or at least 50° C. The maximum treatment temperature can in this context refer to the maximum temperature the substrate with its coating is exposed to during the treatment, i.e. during all steps. This is the equivalent to the temperature of the oven in the thermal annealing step of the prior art. These temperatures are considerably lower than in prior art and allow the use of more temperature sensitive substrates.

In particularly preferred embodiments, during the plasma treatment the substrate temperature does not exceed 400° C., preferably does not exceed 300° C. or does not exceed 150° C. The substrate temperature may be at least 25° C., at least 30° C., at least 35° C., at least 40° C., or at least 50° C. This opens a whole range of new substrates, in particular polymers, for the coating process which had not been usable before due to its temperature sensitivity.

In particularly preferred embodiments, during the entire method, the coating is exposed to a maximum temperature, preferably of at most 150° C. to 400° C., for a duration of at most 0.1 min to 90 min, preferably of at most 0.5 min to 60 min or at most 1 min to 30 min. This maximum temperature here is referring to the actual temperature the substrate and its coating reach when exposed to the treatment and the timespan for which they have this temperature. These preferred conditions result in lower temperatures for shorter times than the thermal annealing step of the prior art while still producing excellent crystallized, low porous, and dense coatings suitable for a multilayer structure.

In embodiments, treating the amorphous coating with a plasma treatment according to step d) forms a crystalized coating having a degree of reflection of 0.05 to 0.3 when determined according to ISO 15368:2001 under an angle of 6° in a range of 250 nm to 850 nm on a coating having a thickness of 100 nm-120 nm, in particular of 0.05 to 0.15 when determined in the range of 250 nm to 380 nm. The degree of reflection is not only an indicator for the crystallinity of the coating but also an important property of the coating.

In highly preferred embodiments, treating the amorphous coating with a plasma treatment according to step d) forms a crystalized coating having a porosity of less than 20%, preferably less than 15%, when determined as the ratio between the inter-crystallite area and the total examined area in a scanning electron microscope (SEM) image. For the determination of the ratio, an SEM image of the coating is made and evaluated by means of image processing. In a predefined examination area having a size of 1.51×1.04 μm², the area of the pores between the crystallites is detected based on the contrast and the difference in brightness, respectively. The porosity is then calculated by dividing the area of the pores through the area of the examination area. Crystalized coatings having a porosity in this range are particularly suitable as a base layer for further layers.

In embodiments, the method may comprise one or more repetitions of steps b) to d) to form one or more further layer(s) of crystalized coating on the crystalized coating formed in the previous repetition, wherein preferably the coating solution in step b) is different from the one of the previous repetition of step b). The application of further different layers of coating can be used to provide the substrate with additional functionalities like described above. For example, a lens may be provided with UV protection, anti-reflection, and anti-scratch properties.

Of course, it is also possible to use the same coating solution more than once in a row if a thicker layer of a certain coating is desired. This may be advantageous because thinner layers are easier to crystallize in a high quality and tend less to the formation of higher porosity than thick layers. Since the coating layers created by the method according to the invention are excellent base layers for further layers, the overall quality of, for example, two layers with half the thickness is higher than a single layer.

Preferably, the substrate comprises or consists of glass, polymers, metals, or alloys or combinations thereof.

In preferred embodiments, the coating solution comprises a metal or a metal oxide, in particular a transition metal or a transition metal oxide, or combinations thereof, preferably ZnO, ZrO₂, TiO₂, VO₂, WO₃, SnO, indium tin oxide, antimony tin oxide, or a precursor of these components, in particular their acetate salts and carbonate salts, and optionally a binder, in particular SiO₂ or TiO₂. With these components, the substrates can be provided with a broad range of functionalities. Precursors will react to the metal or metal oxide during the coating process. They are mainly used due to a better solubility than those which facilitates the preparation of the coating solutions. For this reason, acetate salts and carbonate salts are particularly preferred as precursors. They generally have a good solubility and may readily transferred into their constituting metal or metal oxide. The binders may provide structure to the crystallizing coating.

Preferably, the precursor is decomposed by the action of the plasma into the metal or metal oxide and its organic components which are transferred into the gas phase, preferably the precursor reacts with the plasma gas. The precursors are typically organic compounds of the metals or metal oxides. Hence, the plasma preferably decomposes the precursors and helps to transfer the organic components, like for example CO₂, into the gas phase. This is particularly effectively achieved by a plasma gas which may react with the precursor. In many cases, oxygen is suitable for this purpose. It not only drives off the organic components by oxidation but in addition oxidizes the metal to its oxide which is also the reason why this gas is particularly preferred for coating solutions for metal oxide coatings.

In embodiments, the coating comprises or consists of a metal or a metal oxide, in particular a transition metal or a transition metal oxide, or combinations thereof, preferably ZnO, ZrO₂, TiO₂, VO₂, WO₃, SnO, indium tin oxide, or antimony tin oxide. Like said above, these components can provide the substrates with a broad range of functionalities. In some cases, one or more further components, like additives or activators, may be required for the intended function or structure of the coating. However, typically the coating consists of a single metal or a metal oxide.

In particularly preferred embodiments, step d) forms a crystalized coating having an average crystallite size of less than 40 nm, preferably of less than 20 nm, and of more than 5 nm, preferably of more than 10 nm, when determined on a coating having a thickness of 80 nm-120 nm by means of image processing an SEM image. An average crystallite size within this range has proven itself to be optimal for a very dense coating with low porosity. The inventors have found out that the larger the crystallite size becomes, the larger the pores (and consequently the porosity) become. Moreover, the treatment time can be favorably very short which shortens the process time, saves on energy, and gives very homogeneous particle size distributions.

In preferred embodiments, the morphology of the amorphous coating is modified regarding the state of crystallization and/or the state of modification and/or density and/or surface roughness.

In particularly preferred embodiments, the resulting crystalline coating has a UV absorption of 15% to 90%. The method according to the invention especially suited to produce high quality UV protection coatings. Of course, also other types of functional coatings may equally well be produced with this method.

In embodiments, applying the coating solution in step b) comprises spin coating, printing, spray coating, roll coating, air knife coating, or dip coating the coating solution on the surface of the substrate. Depending on the substrate, the type of coating solution and its viscosity as well as the required thickness, these methods are particularly suitable for the application of the coating solution.

In a second aspect, the invention provides a substrate comprising an at least partially crystalline coating, preferably obtainable by the method according to the invention, wherein the coating has a porosity of less than 20%, preferably less than 15%, when determined as the ratio between the inter-crystallite area and the total examined area in a scanning electron microscope image.

In embodiments, the coating on the substrate has an average crystallite size of less than 40 nm, preferably of less than 20 nm, and of more than 5 nm, preferably of more than 10 nm, when determined on a coating having a thickness of 80 nm-120 nm. This range has proven itself to be optimal for the density and porosity of the coating. Moreover, if the size of the crystallites becomes too small, the proportion of the amorphous structure increases due to the amorphous grain boundary becoming dominant. The crystallite size can be adjusted by the combination of the treatment time and the energy of the plasma. Further, the choice of type of plasma treatment (microwave or radio frequency) has an influence on the general crystallite size. With increasing treatment time, the crystallinity and/or the crystallite size increases.

In a third aspect, the invention provides a substrate, wherein
the substrate comprises glass and/or polymers,
the coating comprises ZnO, and
the average crystallite size of the coating is less than 30 nm.

In a fourth aspect, the invention provides a substrate, wherein
the substrate comprises glass and/or polymers,
the coating comprises ZnO, and
the refractive index of the coating is 1.55 to 2.10 when determined at a wavelength of 590 nm and a thickness of the coating of 100 nm-120 nm.

In embodiments, the coating of the substrate comprises two or more layers, wherein preferably the layers are different from its neighboring layers.

### BRIEF DESCRIPTION OF THE DRAWINGS

FIG. 1 are scanning electron microscope pictures of a ZnO coating prepared in a prior art sol-gel-process with a thermal annealing step (top: after drying, bottom: after annealing).

FIG. 2 are scanning electron microscope pictures of a ZnO coating prepared in a sol-gel-process according to the invention using a 90 min O₂ radio frequency plasma (top: dried sample of FIG. 1, bottom: after annealing).

FIG. 3 are scanning electron microscope pictures of a ZnO coating prepared in a sol-gel-process according to the invention using a 300 s O₂ microwave plasma (top: dried sample of FIG. 1, bottom: after annealing).

FIG. 4 are scanning electron microscope pictures of the annealed ZnO coatings of FIGS. 1-3 for comparison (top: thermally annealed sample of FIG. 1, middle: radio frequency plasma annealed sample of FIG. 2, bottom: microwave plasma annealed sample of FIG. 3).

### DETAILED DESCRIPTION

A ZnO coating on a soda lime glass substrate has been chosen as a model coating to demonstrate the effect of the present invention. Such a ZnO coating is typically provided as a UV protection layer.

### Comparative Example

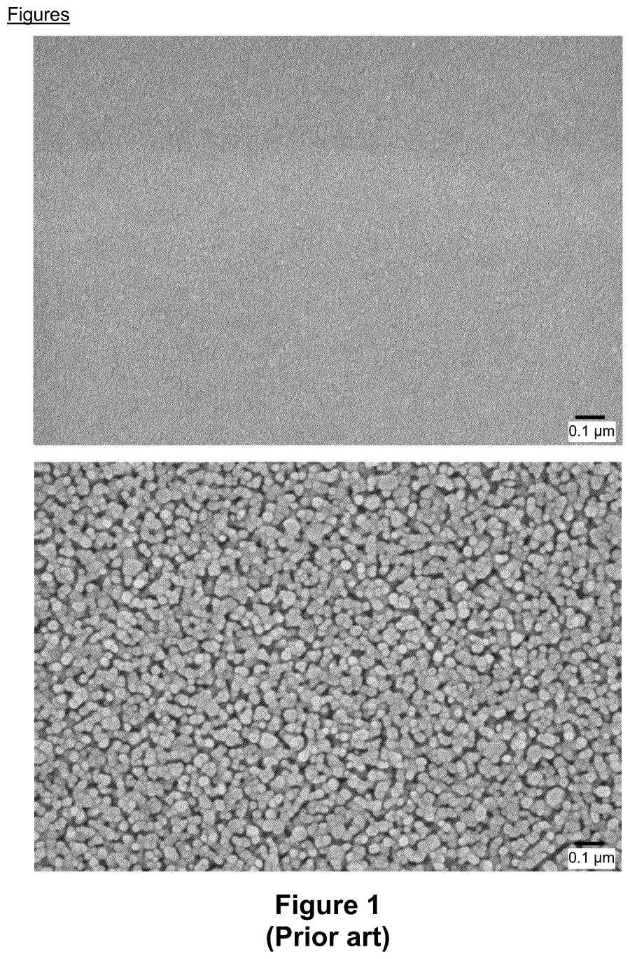

For comparison, in a conventional sol-gel-process of the prior art with a thermal annealing step a corresponding ZnO coating has been prepared. The ZnO coating has applied via dip coating (v=30 cm/min) in an ethanolic solution and dried in a first step for 6 min at 145° C. The dried coating is shown at the top of FIG. 1. It has a thickness of 200 nm-220 nm. Thereafter, the coating has been annealed by heating it at 500° C. for 60 min. The annealed coating is shown at the bottom of FIG. 1. It has a thickness of 110 nm-120 nm. It can be clearly seen in the pictures that the thermal annealing process generates a high open porosity and low density. While the coating is suitable for the intended purpose of UV protection after the annealing step, it will not be possible to apply further layers of other coatings on top of this highly porous layer, for example in order to provide also a anti reflective effect or scratch resistance.

Further, for quantification of the effect, the 2D porosity of the coating has been measured, as described above, by means of scanning electron microscope pictures and image processing. The samples of the standard sol-gel-process with thermal annealing showed a porosity of 26.7% which is too high for a further a further coating layer to sufficiently bond to it.

### First Example

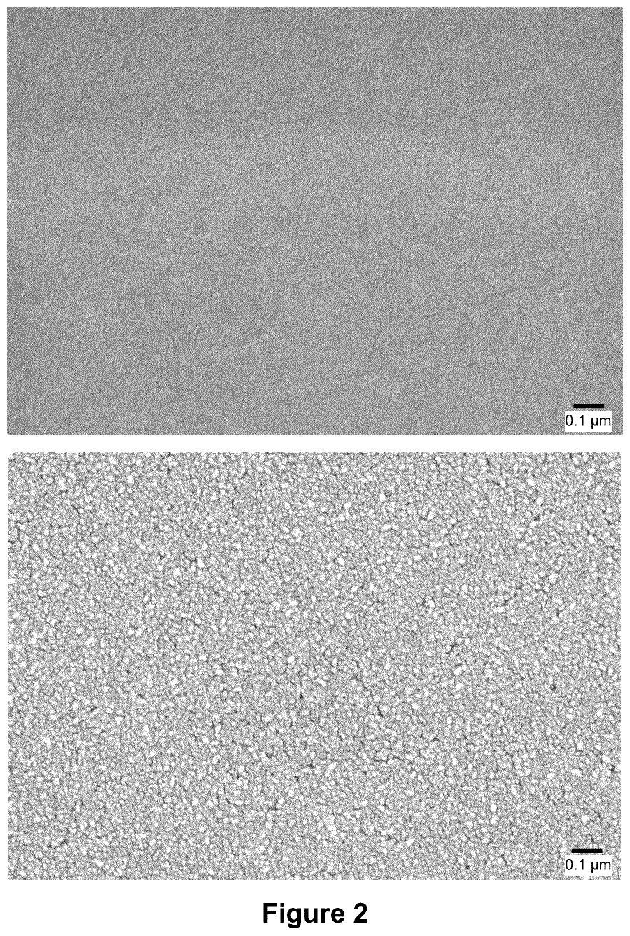

For the examples according to the invention, the sol-gel-process of the comparative example described above has been repeated for the first step. The resulting dried coating has in the first example then been subjected to a radio frequency plasma in an oxygen atmosphere for 90 min. The plasma has been generated with a capacitive electrode arrangement at 540 W using the standard frequency of 13.56 MHz. The substrate temperature did not exceed 250° C. during the plasma treatment. The annealed coating is shown at the bottom of FIG. 2. It has a thickness of 100 nm-120 nm. When compared with the annealed coating of the reference sample, the radio frequency plasma treated example has a much smaller grain size, a denser structure (as confirmed by reflectivity measurements as an indicator), and a higher crystallinity. Oven experiments have confirmed that these effects are not just an effect of the reduced substrate temperature but clearly are caused by the action of the plasma.

The 2D porosity of the coating has been measured to be 7.4%. This dramatic improvement in the porosity makes the coating suitable for further layers of coatings. While the treatment time has been increased over the thermal treatment time in this example, the temperature of the substrate still has been reduced to its half (500° C. to 250° C.). And the porosity, density, and crystallite size are much better than in the reference. This makes the radio frequency plasma the perfect choice for coating solutions which might be degraded by high energy treatment. Moreover, treatment times in the range of 60 min are also possible because the porosity of the coating is then already in a suitable range for further layers of coatings.

### Second Example

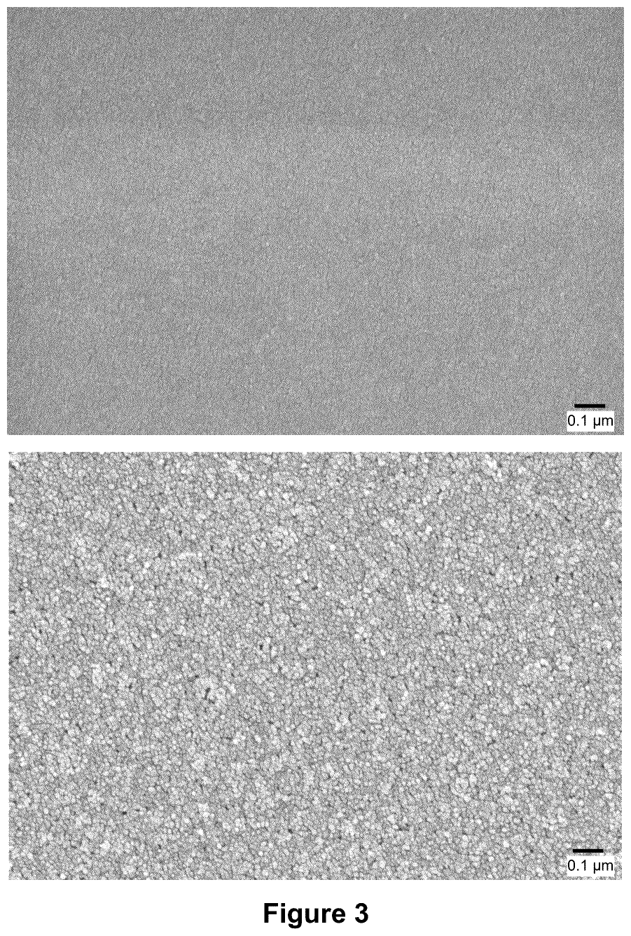

For the second example, the plasma treatment step has been conducted with a magnetron generated microwave plasma in an oxygen atmosphere for 300 s. The magnetron has been operated with an average power of 2.2 kW at the standard frequency of 2.45 GHZ. Also in this case, the substrate temperature did not exceed 250° C. during the plasma treatment. The annealed coating is shown at the bottom of FIG. 3. It has again a thickness of 100 nm-120 nm. The 2D porosity of the coating has been measured to be 7.1%. When compared with the annealed coating of the first example, the microwave plasma treated example has an even smaller grain size, even denser structure, and even higher crystallinity. The porosity is only slightly smaller than in the first example, where already an excellent value has been achieved. Regarding the treatment time, a reduction by a factor of 12 is achieved when compared to the thermal annealing of prior art (300 s vs. 60 min). The higher energy input of the microwave plasma makes it further possible to use other precursors than in prior art which do not readily decompose and, hence, would require even higher temperatures in a thermal treatment step.

These examples show that the method according to the invention has many parameters associated with the plasma treatment which allow for a tailoring of the properties of the resulting coating and that the plasma treatment in general produces far better quality than the thermal treatment of the prior art. In addition to this, the method is more versatile since a broader choice of coating solutions and substrates gets at hand.

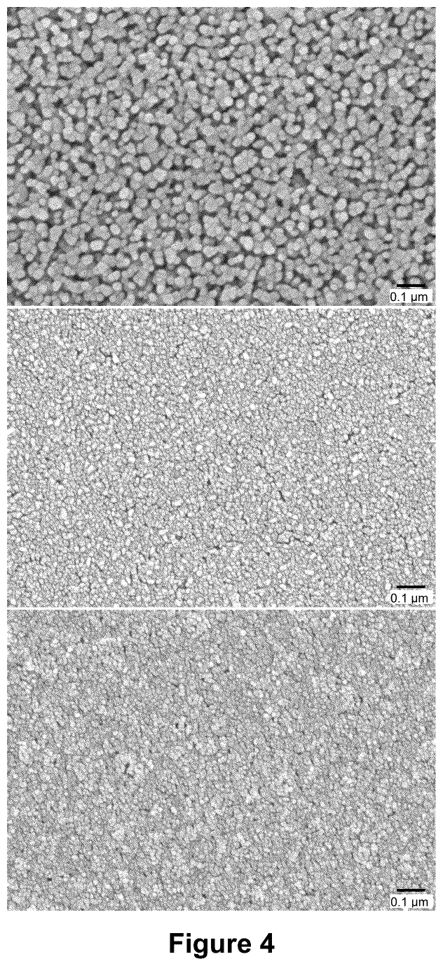

In FIG. 4, the annealed coatings are shown in direct comparison for an overview of the improved porosity. The following table summarizes the respective 2D porosities.

| Annealing step | thermal | RF plasma | microwave plasma |
|---|---|---|---|
| 2D porosity | 26.7% | 7.4% | 7.1% |

What is claimed is:

1-26. (canceled)

27: A method for coating a substrate comprising the steps of:
a) providing a substrate,
b) applying a coating solution on a surface of the substrate,
c) thermally drying the coating solution to form an amorphous coating, and
d) treating the amorphous coating with a plasma treatment to form an at least partially crystalized coating.

28: The method as recited in claim 27 wherein the coating solution is a sol-gel based coating solution and is applied in a sol-gel-process.

29: The method as recited in claim 27 wherein a maximum treatment temperature does not exceed 400° C.

30: The method as recited in claim 27 wherein during an entirety of the method, the coating is exposed to a maximum temperature of at most 150° C. to 400° C. for a duration of at most 0.1 min to 90 min.

31: The method as recited in claim 27 wherein the treating the amorphous coating with the plasma treatment according to step d) forms a crystalized coating having a degree of reflection of 0.05 to 0.3 when determined according to ISO 15368:2001 under an angle of 6° in a range of 250 nm to 850 nm on a coating having a thickness of 100 nm-120 nm.

32: The method as recited in claim 27 wherein the treating the amorphous coating with the plasma treatment according to step d) forms a crystalized coating having a porosity of less than 20% when determined as a ratio between an inter-crystallite area and a total examined area in a scanning electron microscope image.

33: The method as recited in claim 27 further comprising one or more repetitions of steps b) to d) to form one or more further layer of further crystalized coating on the crystalized coating.

34: The method as recited in claim 27 wherein the substrate includes glass, polymers, metals, or alloys or combinations thereof.

35: The method as recited in claim 27 wherein the coating solution includes a metal or a metal oxide.

36: The method as recited in claim 35 wherein a precursor is decomposed by the action of the plasma treatment into the metal or metal oxide and organic components transferred into a gas phase.

37: The method as recited in claim 27 wherein the coating includes a metal or a metal oxide.

38: The method as recited in claim 27 wherein step d) forms a crystalized coating having an average crystallite size of less than 40 nm when determined on a coating having a thickness of 80 nm-120 nm via image processing an SEM image.

39: The method as recited in claim 27 wherein the plasma treatment includes creating a radio frequency plasma or a microwave plasma.

40: The method as recited in claim 27 wherein plasma of the plasma treatment is created in an atmosphere of oxygen, argon, nitrogen, air, or hydrogen either at ambient pressure or at reduced pressure.

41: The method as recited in claim 27 wherein a time of the plasma treatment is from 0.1 s to 120 min.

42: The method as recited in claim 27 wherein during the plasma treatment the substrate temperature does not exceed 400° C.

43: The method as recited in claim 27 wherein a plasma of the plasma treatment is generated via a radio frequency plasma generator with a capacitive electrode arrangement or a pulsed magnetron microwave generator.

44: The method as recited in claim 27 wherein a generator for generation of plasma of the plasma treatment is operated at a power of 0.2 kW-10 kW.

45: The method as recited in claim 27 wherein a morphology of the amorphous coating is modified regarding a state of crystallization or a state of modification or density or surface roughness.

46: The method as recited in claim 27 wherein the crystalized coating has a UV absorption of 15% to 90%.

47: The method as recited in claim 27 wherein applying the coating solution in step b) includes spin coating, printing, spray coating, roll coating, air knife coating, or dip coating the coating solution on the surface of the substrate.

48: A substrate comprising:
an at least partially crystalline coating, wherein the coating has a porosity of less than 20% when determined as a ratio between an inter-crystallite area and a total examined area in a scanning electron microscope image.

49: The substrate as recited in claim 48 wherein the coating has an average crystallite size of less than 40 nm when determined on a coating having a thickness of 80 nm-120 nm.

50: The substrate as recited in claim 48 wherein:
the substrate includes glass or polymers,
the coating includes ZnO, and
an average crystallite size of the coating is less than 30 nm.

51: The substrate as recited in claim 48 wherein:
the substrate includes glass or polymers,
the coating includes ZnO, and
a refractive index of the coating is 1.55 to 2.10 when determined at a wavelength of 590 nm and a thickness of the coating of 100 nm-120 nm.

52: The substrate as recited in claim 48 wherein the coating includes two or more layers.
